(19) United States
(12) Patent Application Publication
(10) Pub. No.: US 2007/0172577 A1
(43) Pub. Date: Jul. 26, 2007

(54) MEAT TREATMENT SYSTEMS AND METHODS

(75) Inventor: Rudy Steiner, Wichita, KS (US)

Correspondence Address: CARGILL INCORPORATED, LAW DEPT/MS 24, 15407 MCGINTY ROAD W, WAYZATA, MN, 55391, US

(73) Assignee: Cargill, Incorporated, Wayzata, MN (US)

(21) Appl. No.: 11/617,149

(22) Filed: Dec. 28, 2006

Related U.S. Application Data
(60) Provisional application No. 60/755,651, filed on Dec. 30, 2005.

(51) Int. Cl. A23L 1/31

(52) U.S. Cl. 426/646

(57) ABSTRACT

The present invention relates to the use of carbon monoxide as a process aid to enhance the re-bloom of ground beef after packaging in a chub. In the present invention the ground beef is exposed to a treatment gas containing carbon monoxide before being packaged in the chub. The carbon monoxide converts some amount of the myoglobin in the ground beef into carboxymyoglobin, which has a desirable bright-red color. The carboxymyoglobin is not transformed to deoxymyoglobin while in the chub by the enzymes present in the meat. Therefore, when the chub is opened by a consumer or intermediate retailer the presence of the carboxymyoglobin enhances the re-bloom.

### CROSS-REFERENCE TO RELATED APPLICATIONS

This application claims priority to U.S. provisional patent application No. 60/755,651 filed Dec. 30, 2005, and entitled “Meat Treatment Systems and Methods,” which is hereby incorporated by reference in its entirety.

### FIELD OF THE INVENTION

The present invention relates to meat processing. More particularly, the present invention relates to a method for utilizing carbon monoxide for enhancing the color of ground meat packaged in chubs and for producing a ground meat product that has enhanced re-bloom properties.

### BACKGROUND OF THE INVENTION

Certain types of fresh (i.e., raw) meat, such as fresh beef, are associated with a red color by consumers. It known that the quantity and form of myoglobin in such fresh meat is a major factor in the color of many fresh meat products, including fresh ground beef, at the time of sale and/or consumption. Myoglobin is a protein present in meat that helps transport oxygen throughout the muscle cell to produce energy. The three major forms of myoglobin in red meat are oxymyoglobin (MbFe(II)O₂), deoxymyoglobin (free of oxygen) and metmyoglobin (MbFe(III)) As used herein the term “myoglobin” is not limited to a particular myoglobin form.

The red color commonly associated with meat products occurs when oxymyoglobin is predominantly present in a meat product. Metmyoglobin, however, is the most stable natural form of myoglobin, and over time, most or all of the myoglobin converts to metmyoglobin under normal environmental conditions. The brown/tan/green color caused by the presence of substantial amounts of metmyoglobin in meat products is not associated with fresh or desirable fresh meat by the consumer.

Accordingly, various approaches have been made to package fresh ground beef and other ground red meat products such that the myoglobin in the meat product is predominantly in the form of oxymyoglobin at the time of display and/or consumption. One approach has been to utilize modified atmosphere packaging (“MAP”), in which the ground meat is enclosed in a gas impermeable container that includes a modified atmosphere. One such modified atmosphere is a low O₂ environment, in which oxymyoglobin and metmyoglobin are converted into deoxymyoglobin. The ground meat goes through this process because the enzymes in the ground beef first consume the remaining oxygen in the ground beef to form metmyoglobin, and then reduce the metmyoglobin to form deoxymyoglobin (referred to herein as the “enzymatic reduction of myoglobin”). Upon exposure to oxygen, the ground beef “re-blooms” as the deoxymyoglobin converts again to oxymyoglobin to produces a desirable red color.

It is also known generally known to introduce carbon monoxide into low O₂ MAP environments to convert at least a portion of the myoglobin present in the ground meat to carboxymyoglobin, MbFe(II)CO. Carboxymyoglobin exhibits a bright cherry-red color that may be desirable to the consumer. In addition, carboxymyoglobin is more stable than other forms of myoglobin under most conditions.

It is not, however, always feasible or commercially viable to use MAP packaging techniques for ground beef. In some operations, for example, ground beef is packaged as a chub. A chub is ground beef or another ground meat packaged in a tube shape. Chub packages are normally elongate tubular flexible packages which are gathered at their opposed ends and sealed to provide a substantially oxygen impermeable package. The ends of the packages may have metal clips clinched around the gathered ends to help with closure. Because the chub packaging is tightly fitted around the ground beef, MAP packaging techniques, which require free space to introduce a modified atmosphere, are not suitable for use on chubs.

When ground beef is first formed by mincing, grinding, cutting or chopping whole muscle, cell walls are broken down and air is introduced into the meat. At this time the ground beef blooms to a desirable bright cherry-red color due to the oxygen present in the air. After packaging as a chub, a predominant portion of the myoglobin present in the ground beef converts to deoxymyoglobin. When the chub package is opened by the retailer or consumer, the ground beef re-blooms to a desirable red color. However, if the re-bloom achieved is not rapid enough, sustained for a sufficient period of time, or if the ground beef does not exhibit sufficient redness, the retailer and/or consumer may not perceive the ground beef as being desirable.

Accordingly, there is a need in the art for methods of enhancing the color achieved during re-bloom of ground beef when the ground beef is exposed to air by the consumer or by an intermediate retailer such as a grocery store.

### BRIEF SUMMARY OF THE INVENTION

In one embodiment, the present invention is a method of processing ground meat. A raw material including myoglobin is obtained and ground. The resulting raw ground meat is then exposed to an effective amount of carbon monoxide prior to packaging to convert a portion of the myoglobin present in the raw ground meat into carboxymyoglobin. The raw ground meat is then packaged into a chub such that at least a portion of the carboxymyoglobin is present in the raw ground meat upon opening the chub, thereby enhancing the re-bloom characteristics of the ground meat.

The raw ground beef may be exposed to carbon monoxide at any time prior to enclosing the meat into the chub packaging. In one embodiment, exposure occurs during grinding. In another embodiment, exposure occurs after during or after grinding in a pressurized vessel. In a further embodiment, the ground meat is exposed during a homogenization step. In yet another embodiment, the ground meat is exposed in a hopper stuffer, just prior to being forced into the chub packaging.

Another embodiment of the present invention is a method of producing a ground meat chub from a raw meat material including myoglobin. The raw meat material is first ground and then homogenized by mixing. During homogenization, an effective amount of carbon monoxide gas is injected into the ground meat to convert a portion of the myoglobin present in the meat product into carboxymyoglobin. The ground meat product is then packaged in the form of a chub.

A further embodiment of the present invention is a method for processing beef into a ground beef chub, in which ground beef is exposed to an effective amount of carbon monoxide to convert a portion of the myoglobin into carboxymyoglobin. The ground beef is then packaged as a ground beef chub, and the chub is stored for a sufficient period of time to convert a substantial portion of the oxymyoglobin present in the ground beef into deoxymyoglobin. At least a portion of the carboxymyoglobin, however, remains present in the ground beef chub during storage and up until the chub is opened.

While multiple embodiments are disclosed, still other embodiments of the present invention will become apparent to those skilled in the art from the following detailed description, which shows and describes illustrative embodiments of the invention. The present invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart showing one embodiment of the present invention method.

FIG. 2 is a side plan view of one apparatus for carrying out the present invention method.

### DETAILED DESCRIPTION

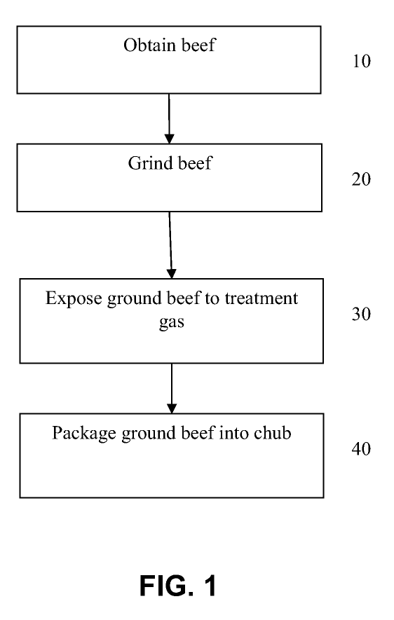

As illustrated in FIG. 1, one embodiment of the present invention is a method of exposing ground beef to carbon monoxide (CO) before packaging the ground beef in a chub. Exposing the ground beef to the CO converts a portion of the myoglobin present in the ground beef to carboxymyoglobin. When packaged and stored as a chub, a substantial portion of the ground beef myoglobin, not previously converted to carboxymyoglobin, converts into deoxymyoglobin through normal processes. The carboxymyoglobin (and the red color exhibited by it) remains such that the color of the re-bloom is enhanced when the ground beef is again exposed to an oxygen containing environment. Enhanced re-bloom can be exhibited, for example, by the ground beef having a more desirable coloration at the time the chub is opened and/or throughout the re-bloom, a more rapid re-bloom upon opening, and/or a longer lasting re-bloom period. As previously noted, this enhancement is caused by the presence and stability of the deoxymyoglobin in the ground beef product.

FIG. 1 is a flow-chart illustrating a method 5 of exposing ground beef to CO according to one embodiment of the present invention. The first step is obtaining the beef to be ground (10). The beef may be any type of beef that is processed by grinding, including steer, heifer, or more mature carcasses. While the present embodiment is described in terms of ground beef, the method may also be applicable to other meat products, including, for example, other beef products, pork, lamb, poultry (e.g., chicken, turkey, etc.), and fish. The present invention is particularly applicable to red meat products containing myoglobin.

The beef is then ground (20) via conventional methods. The beef may be ground to form a finely or coarsely ground beef product. In various embodiments, the beef may be ground using, for example, a ⅝ or ⅜ inch grinding plate. A finer grind may be obtained by using, for example, a ⅛ inch grinding plate. The ground beef may be ground in a desired manner and may include specific types of meat, like chuck or sirloin. In further embodiments finely textured beef may be added to the beef before or after the grinding step. The fat content of the ground beef may also vary.

The ground beef is then exposed to a treatment gas containing CO (30). In one embodiment, the concentration of the CO in the treatment gas is about 0.4% by volume. Alternative embodiments may use a gas containing about 0.01% (by volume) or more CO. Further embodiments may contain up to about 0.1% CO. Still further embodiments may contain about 0.01% to about 0.05% CO. Further embodiments may contain about 0.05-0.1% carbon monoxide, 0.1-0.5% CO, up to and about 0.4% CO, or greater than about 0.5% CO. Although any concentration of CO may theoretically be used, safety and/or cost issues tend to limit the concentration of CO included in the treatment gas.

The CO utilized in this embodiment may be a food grade bulk CO commercially available in pressurized tanks, however, other CO sources could be used as well. In addition to the CO, the treatment gas may include one or more inert gasses, including nitrogen and/or carbon dioxide gas. Suitable treatment gasses including CO are commercially available from Airgas, Inc. (www.airgas.com).

In the present embodiment the ground beef is exposed to the treatment gas in an approximately 1:1 ratio (by volume of ground beef to treatment gas), but may be more or less depending on the needs of the user and the processing methods employed. Additionally, a variety of methods may be used to expose and/or contact the ground beef with CO, several of which are described below.

In one embodiment, the ground beef is exposed to the treatment gas in an exposure chamber. The exposure chamber may be a pressure vessel, a vat, a combo, or any other container to which CO can be added. One such container is discussed in co-pending U.S. patent application Ser. No. 11/253,194, filed on Oct. 18, 2005, which is incorporated herein by reference for all that it teaches and discloses.

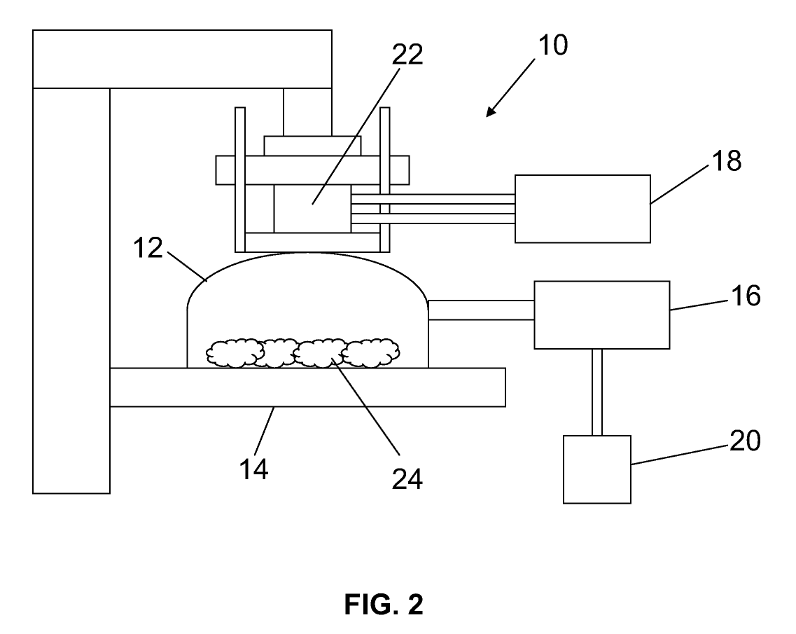

FIG. 2 illustrates an exposure chamber according to another embodiment of the present invention. The exposure chamber 10 includes a pressure vessel 12, a shelf 14, a vacuum control 16, a treatment gas control 18, a vacuum source 20, and a cylinder 22. The chamber 10 may further include an optional fresh air supply via an inlet. The pressure vessel 12 is able to withstand a strong vacuum of up to or greater than approximately 29.92 in/Hg (absolute) and a pressure up to several atmospheres. During operation, the ground beef 24 is placed on the shelf 14. The pressure vessel 12 is then lowered onto the shelf by the cylinder 22 to create a seal between the lower edge of the pressure vessel 12 and the shelf 14. A vacuum is then applied using the vacuum control 16 and the treatment gas is introduced into the pressure vessel using treatment gas control 18. Once treatment has been completed, the pressure vessel is lifted and the ground beef 24 is removed for additional processing and/or packaging. The ground beef 24 may be moved into and out of position on the shelf 12 with a conveyor or by other means.

In this and other embodiments, the vacuum may be applied to the ground beef 24 to remove as much of the free oxygen as possible before applying the treatment gas, thereby increasing the ability and ease of binding the CO to the myoglobin. Other embodiments need not utilize a vacuum step or may instead flush the beef with an inert atmosphere before exposure to the treatment gas as further detailed below. The ground beef is then left in the pressure vessel 12 to be exposed to the treatment gas containing the CO.

In one embodiment, ground beef is exposed to the treatment gas in the pressure vessel for approximately 10 minutes. Exposing the ground beef for approximately 10 minutes allows the CO to penetrate the ground beef such that at least some of the myoglobin converts to carboxymyoglobin. In other embodiments the amount of time may vary from less than a minute to more than 10 minutes. Moreover, the ground beef may absorb some residual amount of CO that does not immediately bond with myoglobin to form carboxymyoglobin. After removal of the ground beef from the pressure vessel some ongoing conversion of the myoglobin to carboxymyoglobin may occur because of the CO absorbed into the ground beef.

The pressure of the treatment gas in the exposure chamber can be normal or elevated. Exposing the ground beef to the CO under pressure may improve the penetration of the CO into the ground beef and speed the absorption of the CO by the ground beef. In one embodiment the pressure may be just slightly more than one atmosphere while in additional embodiments the pressure may be as high or higher than 100 psi or more. In another embodiment, the pressure of the vessel 12 is approximately 6 atmospheres. By way of example, exposing the ground beef to the treatment gas containing 0.4% CO at approximately 100 psi for approximately 10 minutes may convert up to 5-10% or more of the myoglobin present in the meat to carboxymyoglobin.

The ground beef is next packaged as chub (40). Packaging ground beef into a chub package may be performed utilizing a variety of machines and methods and is well known to those in the art. The size of the chubs may be from one pound or less up to or more than 20 pounds. Larger chubs are often opened by retailers and then divided into smaller amounts for sale. The material forming the chub container is generally oxygen impermeable, and may be opaque or clear and may include any number of designs or packaging information. The present invention may be utilized for packaging ground beef in bulk chubs, consumer sized chubs, or other types of packaging intended for commercial suppliers or consumers where the packaging allows for the enzymatic reduction of the myoglobin in the ground beef. The bulk chubs for intermediate retailers are often clear so the purple deoxymyoglobin color can be directly observed. Consumer chubs are most often opaque and so the purplish color is only observed when the package is opened and until the meat re-blooms. In the present invention, however, the presence of carboxymyoglobin may increase the redness of the ground beef even when deoxymyoglobin is present.

In the present embodiment the ground beef or other meat product may be processed and stored before and after exposure to the treatment gas between about 30° F. and about 40° F. In further embodiments the ground beef may be stored between about 30° F. and about 35° F. or about 36° F. and about 40° F. The selected temperature may be suitable for preserving the freshness of the meat and may also be at a temperature that optimizes the activity of the enzymes and myoglobin in relation to the preservation of the meat. Colder temperatures than those listed above may be utilized but may slow the binding of the CO to the myoglobin. The temperature and quality of the myoglobin may also affect the rate at which the myoglobin (whether metmyoglobin or deoxymyoglobin) is changed to carboxymyoglobin by the CO. Other meat products may be held at different temperatures for purposes of storage and during or after exposure to the treatment gas.

While in the chub, the ground beef undergoes the enzymatic reduction of the myoglobin, i.e., the conversion of oxymyoglobin to deoxymyoglobin. A chub of ground beef may have a shelf life, for example of approximately 21 days. Because of the relatively strong stability of carboxymyoglobin, however, the myoglobin that has formed carboxymyoglobin will remain in that form. After being stored for some time in the chub (depending on the age and type of meat) the myoglobin will be predominantly in the deoxymyoglobin form, with the remaining myoglobin being predominantly carboxymyoglobin. The chub should be stored for a time sufficient to convert a desired amount, usually substantially all, of the oxymyoglobin to deoxymyoglobin.

When the chub is initially opened by the consumer or intermediate retailer the ground beef will appear purplish because the myoglobin is predominantly in the deoxymyoglobin form. Assuming that the meat is stored properly, at the correct temperature, and for the right amount of time, when the chub is opened and exposed to oxygen the ground beef will re-bloom. Re-blooming converts the deoxymyoglobin back into oxymyoglobin and causes the ground beef to display a desirable cherry-red color. The presence of the carboxymyoglobin enhances the speed and the displayed color of the re-bloomed meat product because less deoxymyoglobin needs to be converted.

Several variations can be made to the method described with reference to FIGS. 1 and 2. In one variation the ground beef and the chub container are flushed during packaging with a gas, such as carbon dioxide, that does not contain free oxygen. Reducing the amount of oxygen sealed into the chub with the ground beef will hasten the conversion of the oxymyoglobin to deoxymyoglobin.

In another variation, the beef may be exposed to the CO treatment gas during the grinding process in addition to, or as an alternative to, exposing the beef in a separate treatment vessel. In some instances the ground beef goes through a first grinder that grinds the beef using, for example, a ⅜ inch grinding plate and then a second grinder that grinds the beef, using, for example, a ⅛ inch plate. Exposing the ground beef to the CO during grinding can be accomplished during one or both of these grinding steps. For example, the grinder or grinder head may be contained in a chamber that is substantially sealed so as to expose the meat to the treatment gas during grinding. In alternative embodiments, a flow of the treatment gas may be passed over the ground beef as it is ground or right after it is ground. In any of these embodiments the treatment gas can be collected after the ground beef is exposed utilizing a hood, vacuum, fans, pipes or other gas collection devices. The treatment gas flow rate and mixture may be controlled by a computer and monitored by gas flow equipment using equipment known to those in the art.

In a further embodiment, the ground beef is exposed to the CO during transportation of the ground beef between grinding steps, after the grinding and before packaging, or at any other time in the production process. For example, a screw conveyor that transports the ground beef between various steps may include gas nozzles or other gas delivery mechanisms to continually pump gas over and into the ground beef. The nozzles may be incorporated into the screw conveyor by any method known to those in the art.

In yet another embodiment, the ground beef is exposed during homogenization and blending operations, which occur after grinding the meat. After initial grinding, the ground beef may require blending to homogenize the fatty and lean parts of the meat. The homogenization may be done for up to, for example, 90 seconds. In other embodiments the homogenization may occur for approximately 4 minutes or more. The homogenization may occur in a vat or other container utilizing multiple shafts with intermeshed paddles and may be performed as a batch or continuous process. In either case, nozzles or other gas delivery devices may be incorporated into the shafts, paddles, or walls of the container in order to expose the ground beef to the treatment gas. The treatment gas may be pumped over and into the ground beef as it is homogenized. The ground beef may be removed from the homogenization step by a displacement screw that pushes the ground beef through a pipe.

In certain embodiments, it may be desired to inject the treatment gas into the ground beef directly instead of exposing just the outer layer. Injecting the treatment gas may result in a more even exposure of the ground beef to the treatment gas. If the treatment gas is only run over the top of the ground beef then the carboxymyoglobin may be concentrated in certain areas. Injecting the treatment gas or exposing the treatment gas during homogenization and blending may therefore result in a more homogenous distribution and a greater amount of myoglobin being converted to carboxymyoglobin.

In another alternative embodiment the ground beef may be exposed just prior to placing the ground beef into the chub package. The ground beef may be exposed by running a continuous stream of the treatment gas over and about the area where the tube of ground beef is formed. In addition, the treatment gas can be injected into the ground beef while the beef is being formed into the proper shape. Devices useful for exposing the ground beef during or right before packaging in the chub are discussed in U.S. Pat. Nos. 6,685,549 and 6,767,277, which are both incorporated herein by reference for all that they teach and disclose. These patents generally discuss systems including a stuffer hopper for receiving ground beef and for forcing the ground beef out of a stuffer outlet into the chub packaging. A gas treatment can be carried out in the stuffer hopper.

When the ground beef is exposed to the treatment gas containing the CO after it has been formed into a tube, substantially only the outside surface of the ground beef is exposed to the treatment gas. When the chub is opened and re-blooms, therefore, the color of the outside surface of the ground beef will be enhanced by the presence of carboxymyoglobin. However, where the ground beef is more uniformly exposed the packaged chub may have carboxymyoglobin spread throughout its entire diameter. Depending on how the chub package is opened by the consumer or the intermediate retailer may affect the desired method.

Exposing the ground beef to the treatment gas with the CO may be done on a continuous or on a batch basis. If the ground beef production cycle is run as a continuous basis then the exposure may be in a place where the ground beef can be exposed on a continuous basis. Alternatively, if the ground beef production is run on a batch basis, then the exposure of the ground beef can be on a continuous or batch basis depending on the production step where the exposure takes place.

In further embodiments, the volume and pressure of treatment gas may change depending on the concentration of CO, the pressure of the gas, the type of meat, the age of the meat, and other factors. In still further embodiments, nitric oxide can be utilized in addition to or as an alternative to CO with similar results.

Waste treatment gas containing CO may be vented out of the production facility and into the atmosphere. In other embodiments, various filters, burners, or other treatment processes or cleaning steps may be utilized on the waste treatment gas to reduce emissions.

Various modifications and additions can be made to the exemplary embodiments discussed without departing from the scope of the present invention. Accordingly, the scope of the present invention is intended to embrace all such alternatives, modifications, and variations as fall within the scope of the claims, together with all equivalents thereof.

1. A method of processing raw ground meat comprising:
obtaining a raw meat material containing myoglobin;
grinding the raw meat material to form raw ground meat;
exposing the raw ground meat product to an effective amount of carbon monoxide to convert a portion of the myoglobin contained in the raw ground meat product into carboxymyoglobin; and
packaging the exposed raw ground meat product into a chub such that at least a portion of the carboxymyoglobin is present in the raw ground meat product upon opening the chub.

2. The method of claim 1 wherein the raw meat material comprises raw beef.

3. The method of claim 1 wherein the exposing step includes exposing the raw ground meat to a treatment gas including carbon monoxide and at least one substantially inert gas.

4. The method of claim 3 wherein the treatment gas includes about 0.4% carbon monoxide by volume.

5. The method of claim 3 wherein the treatment gas includes about 1.0% carbon monoxide by volume.

6. The method of claim 1 wherein the exposing step comprises placing the raw ground meat product in a pressurized vessel and introducing carbon monoxide into the pressurized vessel.

7. The method of claim 6 wherein the carbon monoxide is introduced into the pressurized vessel at a pressure of greater than one atmosphere.

8. The method of claim 6 further comprising treating the raw ground meat product with a vacuum before introducing the carbon monoxide.

9. The method of claim 1 wherein the exposing step includes exposing the raw meat ground meat product to carbon monoxide during grinding.

10. The method of claim 1 further comprising the step of homogenizing the raw ground meat, and wherein the exposing step includes exposing the ground raw meat to carbon monoxide during homogenization.

11. The method of claim 1 further comprising the step of transporting the raw ground meat product for packaging, and wherein the exposing step occurs during transport.

12. The method of claim 1 wherein the packaging step includes the steps of placing the raw ground meat product into a stuffer hopper and then forcing the raw ground meat product out of a stuffer outlet and into a chub package.

13. The method of claim 12 wherein the exposing step includes exposing the raw ground meat product to the carbon monoxide in the stuffer hopper.

14. The method of claim 1 wherein the exposing step includes injecting the carbon monoxide into the raw ground meat product.

15. The method of claim 1 wherein the packaging step includes the step of inserting the raw ground meat product into a substantially oxygen impermeable chub package.

16. A method of producing a ground meat chub comprising:
obtaining a raw meat material containing myoglobin;
grinding the raw meat material to form a raw ground meat product, homogenizing the ground raw meat product by mixing;
injecting a treatment gas into the raw ground meat product during homogenization, wherein the treatment gas includes an effective amount of carbon monoxide to react with a portion the myoglobin in the raw ground meat product to form carboxymyoglobin; and
packaging the ground meat into a chub.

17. A method of processing a beef material into a ground beef chub comprising obtaining a ground beef material that includes myoglobin in the form of oxymyoglobin;
exposing the ground beef to an effective amount of carbon monoxide to convert a portion of myoglobin present in the ground beef into carboxymyoglobin;
packaging the ground beef into a chub; and
storing the chub prior to opening for a sufficient time to convert a portion of the oxymyoglobin present in the chub into deoxymyoglobin, and wherein at least a portion of the carboxymyoglobin remains present in the raw ground meat product.

18. The method of claim 17 wherein the ground beef includes raw ground beef combined with a finely textured beef material.
